(19) United States
(12) Patent Application Publication
(10) Pub. No.: US 2021/0025479 A1
(43) Pub. Date: Jan. 28, 2021

(54) PLANETARY GEARBOX HAVING SINGLE-TOOTH SUN GEAR HAVING EVOLOID TOOTHING

(71) Applicant: MAUL KONSTRUKTIONEN GMBH, Würselen (DE)

(72) Inventor: Hans-Erich MAUL, Aachen (DE)

(21) Appl. No.: 17/040,112

(22) PCT Filed: Mar. 14, 2019
(86) PCT No.: PCT/EP2019/056389

§ 371 Date: Sep. 22, 2020

(30) Foreign Application Priority Data
Mar. 23, 2018 (DE) 10 2018 107 021.7

(51) Int. Cl. F16H 1/28; F16H 57/08

(52) U.S. Cl. CPC F16H 1/2863; F16H 2001/2881; F16H 57/082

(57) ABSTRACT

A planetary gearbox includes a sun gear having one tooth, a ring gear, planet gears, and a planet carrier on which the pant gears are rotatably arranged. Each of the sun gear, the planet gears, and the ring gear have evoloid toothing. The planetary gearbox enables high load capacity at high transmission ratios by using three circulating planetary gears in the ring gear, which is frame-fixed. The planet gears do not hit each other at a high transmission ration of i=24:1 because of defined addendum modification coefficients and addendum coefficients of the individual gears of the planetary gearbox.

The invention relates to a planetary gearbox comprising a sun gear, a ring gear, planet gears and a planet carrier on which the planet gears are rotatably arranged, wherein the sun gear, the planet gears and the ring gear have evoloid toothing. Moreover, the invention relates to a multi-stage planetary gearbox arrangement.

Planetary gearboxes have numerous advantages compared with other types of gearboxes, in particular:
a compact, heavy-duty design,
supporting many teeth simultaneously,
a relatively high transmission ratio in one stage and
a multi-stage arrangement through the series connection of multiple planetary gearboxes.

A generic planetary gearbox with a high transmission ratio is known from WO 2008/079011 A1, said gearbox having two planet gears and a sun gear having one tooth or two teeth, wherein the sun gear, the planet gears and the ring gear have evoloid toothing. The planet gears in this gearbox are frame-fixed and the output takes place via the ring gear. The transmission ratio is i=20:1.

The disadvantage of the planetary gearbox with a high transmission ratio known from WO 2008/079011 A1 is its lower load-bearing capacity compared with the widely used and preferred embodiment of planetary gearboxes with three planet gears.

Planetary gearboxes with three planetary gears have further advantages, in particular
an improved distribution of load over a greater number of planet gears,
a uniform transmission of force in the planet carrier via the axes of the planet gears lying at the corner points of an equilateral triangle, and
a centering of the sun gear relative to the ring gear through the forces exerted by the planet gears.

Fitting the planetary gearbox known from WO 2008/079011 A1 with three planet gears fails at anything above a transmission ratio of roughly i=12:1 because the planet gears would strike one another and collide.

Starting from this prior art, the problem addressed by the invention is that of creating a generic planetary gearbox with evoloid toothing which facilitates a high load-bearing capacity, even at high transmission ratios including i=24:1 in particular.

The solution is based on the principle of equipping a planetary gearbox with evoloid toothing with three rotating planet gears which do not strike one another, even at high transmission ratios. Specifically, the problem is solved by a planetary gearbox having the features of claim 1.

The sun gear comprising only one tooth contributes to the high possible transmission ratios.

In order to reduce the planet gear diameter, a sharp addendum reduction and, in addition, a negative addendum modification of the planet gears is proposed according to the invention. The negative addendum modification coefficient x of each planet gear falls within the range of −0.2 to −0.4. The addendum height coefficient h_{aP} of the planet gear falls within the range of 0.5 to 0.7.

At the same time, the sun gear receives a large positive addendum modification and addendum reduction, so that the diameter of the sun gear is greater. The positive addendum modification coefficient x of the sun gear falls within the range of 1.4 to 1.6. The addendum coefficient h_{aP} of the sun gear falls within the range of 0.1 to 0.2. The number of teeth on the planet gears can be increased to up to 11 on account of the addendum modification and addendum reduction of the sun gear.

The internally toothed, frame-fixed ring gear is subject to a negative addendum modification, as a result of which the used part of the toothing is displaced outwardly. The negative addendum modification coefficient x of the ring gear falls within the range of −0.8 to −1.0. The addendum factor h_{aP} of the ring gear falls within the range of 1.3 to 1.5.

The reference profile of customary gears is standardized in DIN 867.

A planetary gearbox according to the invention can transmit very high output torques with a very small installation space. A planetary gearbox according to the invention has a diameter of roughly 65 mm and a modulus of 1.75 mm, for example.

With a transmission ratio of i=24:1 and an efficiency factor of 94%, the torque in the planetary gearbox is increased by a factor of 22.56. This factor cannot be achieved with planetary gearboxes known in the art.

Each planetary gear mates with the ring gear via a first path of contact and with the sun gear via a second path of contact. If the operating angle of contact of the first path of contact coincides with the operating angle of contact of the second path of contact, the efficiency factor of the planetary gearbox coincides, irrespective of whether the drive takes place via the sun or the planet carrier (web).

The coinciding operating angles of pressure are achieved through symmetrical configuration of the totals of the addendum modifications, i.e. the total addendum modifications for the sun gear and a planet gear corresponds in value terms to the total addendum modifications of a planet gear and the ring gear.

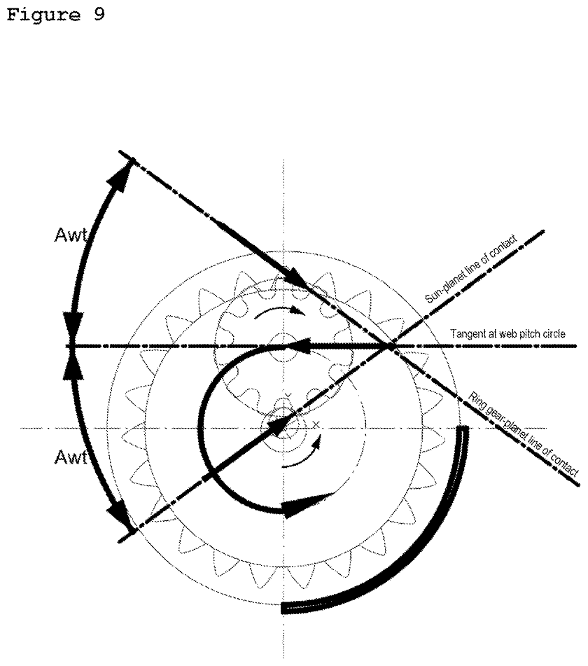

This choice of toothing parameters of the planetary gearbox means that the engagement of the mating teeth of the ring gear and the planet gears after the pitch point and the engagement of the mating teeth of the sun gear and the planet gears before the pitch point, as can be seen for one of the planet gears in FIG. 9.

When the planetary gearbox is driven by the sun gear, the fact that engagement takes place before the pitch point benefits the rotation of the planet gears through progressive (impacting) friction and the fact that the pitch point lies on the ring gear after engagement benefits the running of the planet gears on the ring gear through degressive (dragging) friction.

When the drive is on the planet carrier (web), the fact that engagement takes place before the pitch point benefits the rotation of the sun gear on account of the progressive (impacting) friction and the fact that the pitch point lies on the ring gear after engagement benefits the running of the planet gears on the ring gear through degressive (dragging) friction.

The drive of the planetary gearbox according to the invention customarily takes place via the sun gear and the output via the planet carrier. A reversal of the output is entirely possible, however, and this may be relevant particularly to applications in the automobile industry, for example to body hatches and doors driven via a planetary gearbox.

Due to the small space requirement in a radial direction, the planet gears are rotatably mounted on the planet carrier, preferably by means of needle bearings. The sun gear has a low-friction toe bearing known from precision engineering, which allows a reverse rotation of the planetary gearbox from the output side itself, even with very high transmission ratios in multi-stage planetary gearbox arrangements.

The angle of inclination of the evoloid toothing of the sun gear, of the planet gears, and of the ring gear preferably falls within a range of 30° to 40°. This angle of inclination produces a high transverse contact ratio of roughly 2 which produces good gearbox running properties.

The transmission ratio of the planetary gearbox according to the invention is obtained from

i=(z_{ring gear}/z_{sun gear})+1

where
i=transmission ratio
z=number of teeth.

For a standard transmission ratio of the planetary gearbox i=24:1, the number of teeth on the planet gears is z=11 and the number of teeth on the ring gear is z=23. With good lubrication and the use of suitable materials, a planetary gearbox of this kind has an efficiency factor of over 94%.

A two-stage gearbox arrangement comprising two planetary gearboxes where i=24:1 still has an efficiency factor of over 88% with a total transmission ratio of 576:1. A three-stage gearbox arrangement comprising three planetary gearboxes where i=24:1 still has an efficiency factor of over 83% with a total transmission ratio of 13824:1.

For a planetary gearbox transmission ratio of i=6:1, the number of teeth on the planet gears is z=2 and the number of teeth on the ring gear is z=5. The planetary gearbox where i=6:1 has the lowest transmission ratio that can be achieved with a sun gear where z=1 and a uniform arrangement of three planet gears.

The planetary gearbox where i=6:1 may be enlarged to a module of up to 5.5 mm. This increases the load-bearing capacity of the gearbox.

Between this lowest transmission ratio i=6:1 and the standard ratio i=24:1, planetary gearboxes with the transmission ratio i=12:1 can be realized, wherein the number of teeth of the planetary gears is z=5 and the number of teeth of the ring gear is z=11, or with the transmission ratio i=18:1, wherein the number of teeth of the planetary gears is z=8 and the number of teeth of the ring gear is z=17.

The dimensions, in particular the connection dimensions of the planetary gearboxes, preferably coincide irrespective of the selected transmission ratio. This allows a multi-stage planetary gearbox arrangement made up of planetary gearboxes with the same and/or different transmission ratios to be of modular composition.

Insofar as the planet gears of the first stage, at least, are not made of steel but of plastic, this reduces the noise generated by the gearbox. The remaining gears are made of steel.

The drive of the sun gear in each planetary gearbox takes place via a drive shaft, wherein all drive shafts in the different stages of the planetary gearbox arrangement are aligned with one another. The torque transmission between the individual stages takes place via an Oldham coupling, wherein a tongue is arranged on a first coupling part and a tongue is arranged on a second coupling part, which tongues engage with intersecting grooves in a coupling disc. One of the two tongues is preferably arranged on the front side of the drive shaft of the sun gear and one tongue is arranged on the planet carrier of the preceding stage. The Oldham coupling, also referred to as a Kreuzschlitzkupplung (cross-recess coupling) in the German-speaking area, is a non-switchable, torsionally rigid coupling which can compensate a radial offset of two parallel shafts.

With a planetary gearbox or a multi-stage planetary gear arrangement comprising up to three planetary gearboxes according to the invention which preferably have one of the aforementioned transmission ratios i=6:1, 12:1, 18:1, 24:1, virtually all total transmission ratios from i=6:1 to i=13848:1 can be realized with a step range of 6 according to the arithmetical number sequence.

Tests with planetary gearbox arrangements having two stages with a transmission ratio of i=24:1 in each case, in other words a total transmission ratio of i=576:1, could be turned back relatively easily with the non-energized drive motor on the drive side from the output side.

The invention is explained in greater detail below with the help of the figures. In the figures

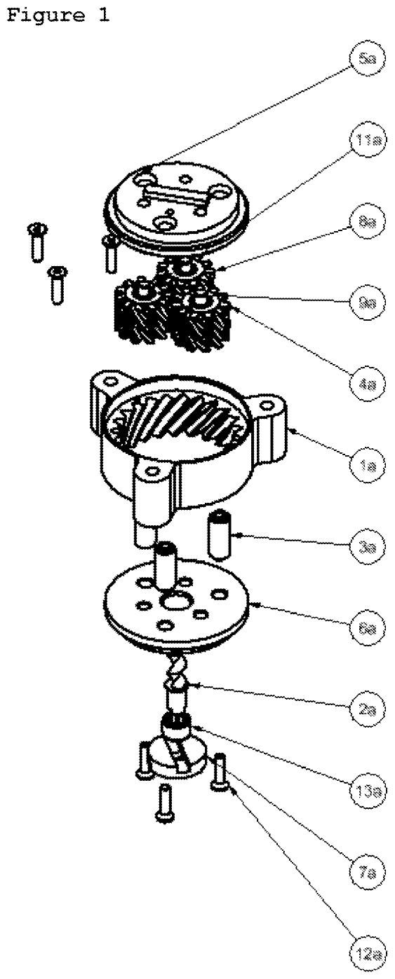

FIG. 1 shows an exploded view of a planetary gearbox according to the invention with a transmission ratio of i=24:1,

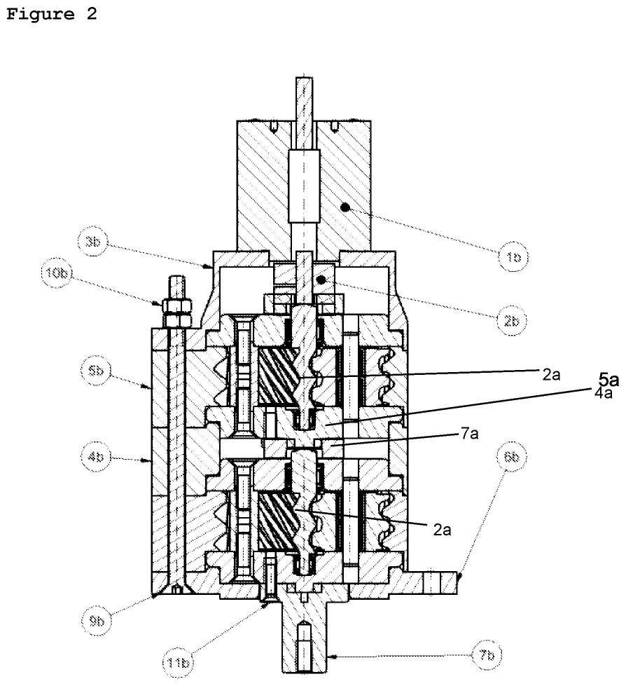

FIG. 2 shows a longitudinal section through a two-stage planetary gearbox arrangement,

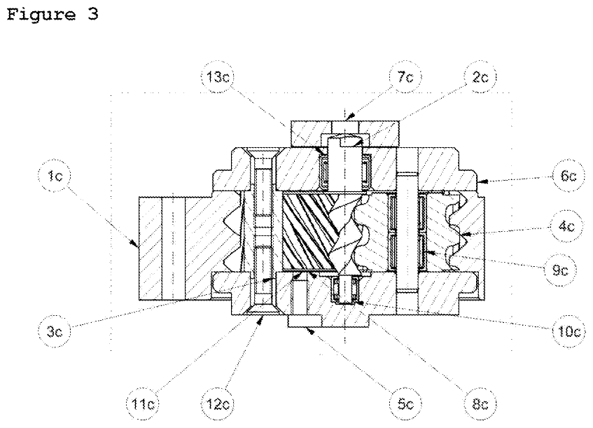

FIG. 3 shows a longitudinal section through a planetary gearbox according to FIG. 1,

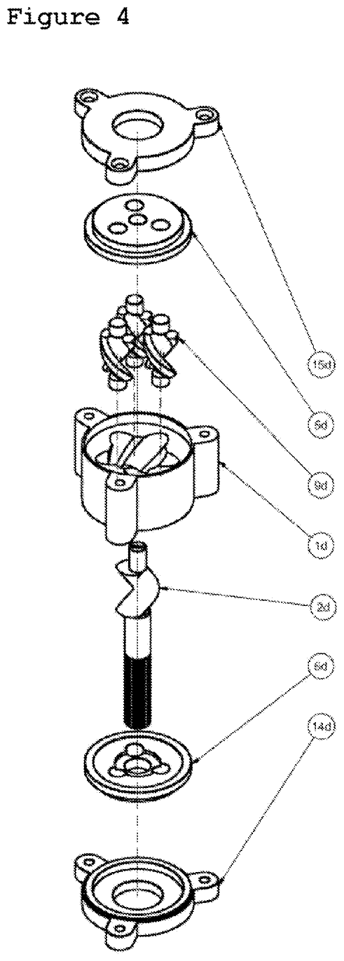

FIG. 4 shows an exploded view of a further exemplary embodiment of a planetary gearbox according to the invention with a transmission ratio of i=6:1,

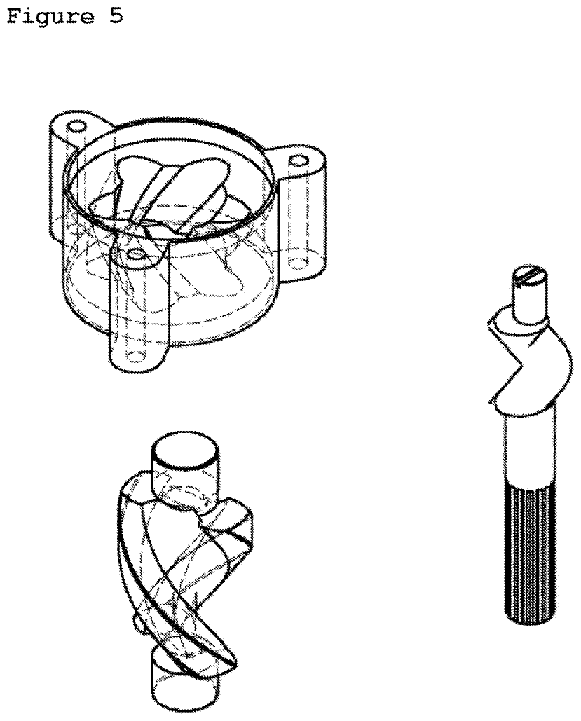

FIG. 5 shows a ring gear, a planet gear and a sun gear of a planetary gearbox according to FIG. 4,

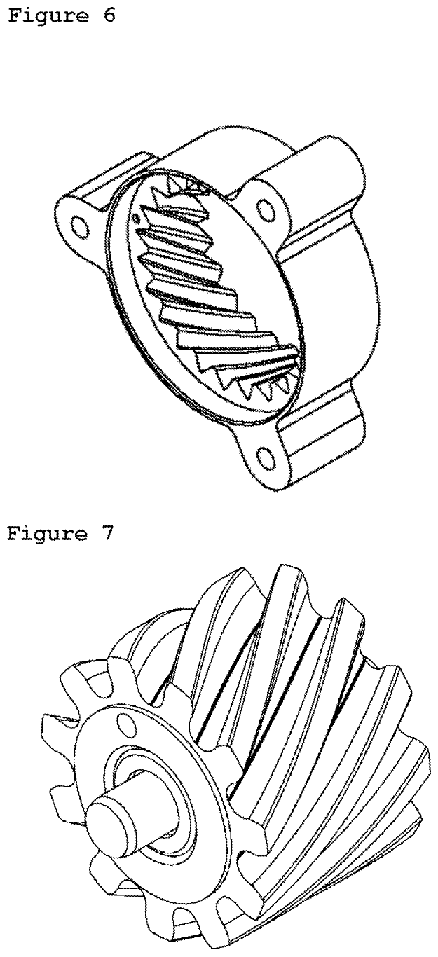

FIG. 6 shows a ring gear of a planetary gearbox according to FIG. 1,

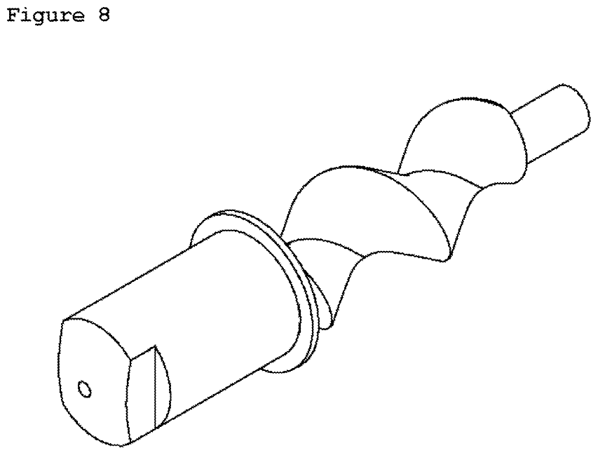

FIG. 7 shows a planet gear made of plastic for a planetary gearbox according to FIG. 1,

FIG. 8 shows a sun gear for a gearbox according to the invention with a drive shaft, and

FIG. 9 shows a representation intended to illustrate the operating angle of contact between the planet gears and the ring gear, on the one hand, and the planet gears and the sun gear, on the other, of a planetary gearbox according to the invention.

The planetary gearbox according to FIG. 1 comprises a sun gear (2a), a frame-fixed ring gear (1a), three planet gears (8a), and a planet carrier (4a). The ring gear (1a) is depicted in detail in FIG. 6, the planet gear (8a) in detail in FIG. 7, and the sun gear (2a) in detail in FIG. 8. The sun gear (2a) comprising only one tooth is arranged on the drive shaft in a non-rotatable manner and mates with the three planet gears (8a) which each have eleven teeth. In the exemplary embodiment shown, the planet gears (8a) are produced from plastic in order to reduce noise.

Each planet gear (8a) is mounted rotatably via a bearing (9a) about a cylindrical pin (11a). The cylindrical pins extend between two planet carrier discs (5a, 6a) of the planet carrier (4a) arranged in parallel spaced apart from one another. The cylindrical pins (11a) projecting beyond the planet gears (8a) on both sides engage with receiving openings aligned with one another in the planet carrier discs (5a, 6a).

The two planet carrier discs (5a, 6a) of the planet carrier (4a) are, moreover, held spaced apart by hollow support parts (3a). The hollow support parts (3a) are hollow-cylindrical and have internal threads on both sides for receiving screws (12a). Through corresponding bores in the planet carrier discs (5a, 6a) of the planet carrier, the screws (12a) engage through the planet carrier disc into the internal thread of the hollow support parts (3a).

The planet carrier disc (6a) on the drive side has a central bore for receiving a bearing sleeve (13a) which supports the drive shaft of the sun gear (2a) rotatably in the lower planet carrier disc (6a).

The drive of the planetary gearbox takes place via an Oldham coupling comprising a coupling disc (7a) with two intersecting grooves on opposite sides of the coupling disc. A tongue which engages with the groove introduced on the upper side of the coupling disc (7a) is formed on the front side of the drive shaft of the sun gear (2a). A drive shaft of a motor (1b) not shown in FIG. 1 exhibiting a tongue likewise formed on the front side engages with the opposite groove of the coupling disc (7a) (cf. FIG. 2).

The planet carrier (4a) is rotatably mounted in the frame-fixed ring gear (1a). On the outer casing of the ring gear (1a), three holders are arranged over the circumference offset by 120 degrees in respect of one another, said holders each having passages for receiving screws, in order to mechanically connect to one another multiple planetary gearboxes with corresponding dimensions and connection measurements in a multi-stage planetary gearbox arrangement. The passages in the holders extend in the longitudinal direction of the planetary gearbox and also parallel to the rotational axes of the gears of each planetary gearbox lying in a plane.

FIG. 2 shows a two-stage planetary gearbox arrangement which is made up of two planetary gearboxes according to FIG. 1, as follows:

The electric motor (1b) is connected to the first planetary stage (5b) on the front side via a motor adapter (3b). The motor adapter (3b) likewise has holders which are each offset in respect of one another by 120 degrees and which each have a passage for a screw. The passages in the three holders of the motor adapter (3b) are aligned with the passages in the holders of the ring gear (1a).

Behind the first planetary gear stage (5b) is located an adapter (4b) which is arranged between the first planetary gear stage (5b) and the second planetary gear stage (5b). By means of the adapter (4b), the necessary space is created between the stages, in order to couple the output of the planetary gearbox of the first stage with the drive of the planetary gearbox in the second stage. The coupling takes place via an Oldham coupling which comprises a coupling disc (7a). The coupling disc (7a) coincides with the coupling disc (7a) which couples the motor (1b) with the drive shaft of the sun gear (2a) of the first stage.

The planet carrier disc (5a) on the output side (cf. FIG. 1) of the planetary gearbox in the first stage has a tongue on its outwardly facing surface which engages with one of the two grooves in the coupling disc (7a). The tongue of the drive shaft of the sun gear (2a) of the second stage formed on the front side of the drive shaft engages with the groove formed on the opposite side of the coupling disc (7a).

The tongue of the drive shaft of the second stage formed on the front side corresponds geometrically with the tongue of the drive shaft of the first stage formed on the front side. The planet carrier disc of the planetary gearbox on the output side in the second stage has on its outwardly facing surface a tongue corresponding geometrically to the tongue of the first gear stage. On account of the preferably geometrically completely corresponding drives and outputs of all planetary stages and the geometrically corresponding frame-fixed housing (sun gear) including the holders, multiple planetary gearboxes with the same and/or different transmission ratios according to the invention can be connected in series in a multi-stage planetary gearbox arrangement according to FIG. 2.

An end cover, whereof holders (6b) arranged on the circumference correspond to the holders on the ring gears of the two planetary stages (5b), to holders on the motor adapter (3b) and to holders on adapters (4b) arranged between the two planetary stages (5b) is located at the output of the second planetary stage (5b). The passages in each of the three corresponding holders are aligned with one another, in order to receive screws (9b).

The end cover has a passage in the center, through which an output carrier (7b) extends which is fastened to the planet carrier of the second stage on the output side by means of screws (11b). The output torques of the planetary gearbox arrangement are transmitted to the output carriers (7b), in that the tongue on the output side of the planet carrier disc (5a) engages with a groove in the output carrier (7b).

The motor, the two planetary stages and the adapters arranged therebetween and the end cover of the planetary gear arrangement are connected to three screws (9b). The three screws (9b) pass through the passages aligned with one another in the holders (6b) starting from the end cover and are secured at the opposite motor adapter by nuts (10b).

FIG. 3 shows a section through a planetary gearbox corresponding to FIG. 1. The same components are provided with the same numbers but with different letters.

In particular, the arrangement of the drive shaft of the sun gear (2c) can be identified from the sectional representation. On the drive side, the drive shaft is mounted by means of a bearing sleeve (13c) in the planet carrier disc (6c) of the planet carrier (4c). On the output side, the drive shaft is mounted in a toe bearing (10c) in the planet carrier disc (5c) on the output side.

FIG. 4 shows in conjunction with FIG. 5 an exploded view of a planetary gearbox according to the invention having a transmission ratio of i=1:6. Corresponding components, as in the exemplary embodiment according to FIG. 1, are identified using corresponding numbers but different letters. The sun gear (2d) sits on a drive shaft, the drive-side portion whereof extends through the drive-side planet carrier disc (6d) and is connected in a non-rotatable manner to a motor which is not shown, for example. The shaft portion projecting beyond the sun gear (2d) on the output side is mounted in a rotatable manner in a central bore of the planet carrier disc (5d) on the output side.

The planet gears likewise each have shaft stubs on both sides of the planet gear which are received in corresponding bearings in the planet carrier disc (6d) on the drive side and the planet carrier disc (5d) on the output side. The ring gear (1d) has a circumferential web on both front sides of the inner toothing, on which web the planet carrier disc (5d, 6d) on the drive side or the output side is rotatably mounted. In an axial direction of the planetary gearbox, the planet carrier discs (5d, 6d) are each secured between one of the two circumferential webs and a cover (14d, 15d). The fastening of the two covers (14d, 15d) to the frame-fixed ring gear (1d) takes place via the holders fastened to the outer casing of the ring gear, the passages of which are aligned with corresponding passages on holders of the two covers (14d, 15d). The passages serve to receive screws which are not shown in FIG. 4 and which connect the two covers to the ring gear. The output may take place, for example, through a pin inserted in a non-rotatable manner into the central bore in the planet carrier disc (5d).

An optimally toothed planetary gearbox according to the present invention exhibits a positive addendum modification coefficient of +1.52 for the sun gear, a negative addendum modification coefficient of −0.32 for the planet gears, a negative addendum modification coefficient of −0.88 for the ring gear, and an addendum coefficient for the sun gear of 0.165 h_{aP}, an addendum coefficient of 0.672 h_{aP} for the planet gear, and an addendum coefficient of 1.391 h_{aP} for the ring gear. The angle of inclination of the evoloid toothing of all gears is roughly 36 degrees.

### LIST OF REFERENCE NUMBERS

FIG. 1

| | |
|---|---|
| 1a | Ring gear |
| 2a | Sun gear |
| 3a | Hollow support part |
| 4a | Planet carrier |
| 5a | Planet carrier disc |
| 6a | Planet carrier disc |
| 7a | Coupling disc |
| 8a | Planet gear |
| 9a | Planet gear bearing |
| 10a | Bearing |
| 11a | Cylindrical pin |
| 12a | Screw |
| 13a | Bearing sleeve |

FIG. 2

| | |
|---|---|
| 1b | Motor |
| 2b | Oldham coupling |
| 3b | Motor adapter |
| 4b | Adapter |
| 5b | Planetary stage |
| 6b | Adapter holder |
| 7b | Output carrier |
| 9b | Screw |
| 10b | Nut |
| 11b | Screw |

FIG. 3

| | |
|---|---|
| 1c | Ring gear |
| 2c | Sun gear |
| 3c | Hollow support part |
| 4c | Planet carrier |
| 5c | Planet carrier disc |
| 6c | Planet carrier disc |
| 7c | Coupling disc |
| 8c | Planet gear |
| 9c | Planet gear bearing |
| 10c | Sun gear toe bearing |
| 11c | Cylindrical pin |
| 12c | Screw |
| 13c | Bearing sleeve |

FIG. 4

| | |
|---|---|
| 1d | Ring gear |
| 2d | Sun gear |
| 5d | Planet carrier disc |
| 6d | Planet carrier disc |
| 9d | Planet gear |
| 14d | Cover |
| 15d | Cover |

1.-13. (canceled)

14. A planetary gearbox, comprising
a sun gear having a number of teeth is z=1, a positive addendum modification coefficient x that falls within a range of 1.4 to 1.6, and an addendum coefficient h_{aP} that falls within the range of 0.1 to 0.2;
a ring gear that is frame-fixed, the ring gear having a negative addendum modification coefficient x that falls within the range of −0.8 to −1.0 and an addendum factor h_{aP} that falls within the range of 1.3 to 1.5;
three planet gears, each of the three planet gears having a negative addendum modification coefficient x that falls within the range of −0.2 to −0.4 and an addendum height coefficient h_{aP} that falls within the range of 0.5 to 0.7; and
a planet carrier on which the three planet gears are rotatably arranged, the
wherein the sun gear, the three planet gears, and the ring gear each have evoloid toothing.

15. The planetary gearbox as claimed in claim 14, wherein each of the three planetary gears mate with the ring gear via a first path of contact and with the sun gear via a second path of contact, and
an operating angle of contact of the first path of contact coincides with an operating angle of contact of the second path of contact.

16. The planetary gearbox as claimed in claim 14, wherein the planet gears are rotatably mounted on the planet carrier via needle bearings.

17. The planetary gearbox as claimed in claim 14, wherein an angle of inclination of the evoloid toothing of each of the sun gear, the three planet gears, and the ring gear falls within a range of 30° to 40°.

18. The planetary gearbox as claimed in claim 14, wherein a transmission ratio of the planetary gearbox is i=6:1, the number of teeth on each of the three planet gears is z=2, and the number of teeth on the ring gear is z=5.

19. The planetary gearbox as claimed in claim 14, wherein a transmission ratio of the planetary gearbox is i=12:1, the number of teeth on each of the three planetary gears is z=5, and the number of teeth on the ring gear is z=11,

20. The planetary gearbox as claimed in claim 14, wherein the transmission ratio of the planetary gearbox is i=18:1, the number of teeth on each of the three planetary gears is z=8, and the number of teeth on the ring gear is z=17.

21. The planetary gearbox as claimed in claim 14, wherein the transmission ratio of the planetary gearbox is i=24:1, the number of teeth on each of the three planet gears is z=11, and the number of teeth on the ring gear is z=23.

22. A multi-stage planetary gearbox arrangement comprising at least two planetary gearboxes as claimed in claim 14.

23. The multi-stage planetary gearbox arrangement as claimed in claim 22, wherein each of the at least two planetary gearboxes is driven via the sun gear and an output of the each of the at least two planetary gearboxes is the planet carrier.

24. The multi-stage planetary gearbox arrangement as claimed in claim 23, further comprising drive shafts, wherein each of the drive shafts drives the sun gear of a respective one of the each of the two planetary gearboxes and the drive shafts are aligned with one another.

25. The multi-stage planetary gearbox arrangement as claimed in claim 24, wherein each pair of the at least two planetary gearboxes are connected to one another via an Oldham coupling.

26. The multi-stage planetary gearbox arrangement as claimed in claim 25, wherein
each of the at least two planetary gearboxes includes a tongue arranged in a non-rotatable manner on the drive shaft of the sun gear on the front side and a tongue is arranged in a non-rotatable manner on an output side of the planet carrier,
the Oldham coupling includes a coupling disc with two intersecting grooves on opposite sides of the coupling disc,
wherein the tongue of the drive shaft and the tongue of the planet carrier of the each of the at least two planetary gearboxes to be coupled to one another engage with the intersecting grooves.
